(19) United States
(12) Patent Application Publication
(10) Pub. No.: US 2010/0007486 A1
(43) Pub. Date: Jan. 14, 2010

(54) Wireless Infant Alarm System

(76) Inventor: Jau-Jang Lu, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/371,655

(22) Filed: Feb. 16, 2009

(30) Foreign Application Priority Data
Jul. 14, 2008 (TW) 097212523

(51) Int. Cl. G08B 1/08

(52) U.S. Cl. 340/539.15

(57) ABSTRACT

A wireless infant state alarm system includes a detecting device placed adjacent an infant. The detecting device includes an external signal receiver for receiving an external signal indicative of at least one of movement and sound of the infant. The detecting device further includes a signal transmitter receiving and converting the external signal into a wireless signal indicative of at least one of the movement and the sound of the infant and transmitting the wireless signal. An alarm device is placed adjacent a guardian of the infant and includes a signal receiver and a vibrator. The signal receiver receives the wireless signal from the signal transmitter, and the vibrator vibrates to alert the guardian of a state of the infant.

### BACKGROUND OF THE INVENTION

The present invention relates to a wireless alarm system and, more particularly, to a wireless alarm system for monitoring crying or abnormal movement of an infant and sending a signal to an infant state alarm device carried by a guardian remote from the infant.

Guardians of the infants needing regular care often can not concentrate on other things. To help the guardians, a remote monitoring system for monitoring the state of an infant has been proposed. Such a system includes a monitor for picking up images and a video player synchronously receiving the images. The video player includes a loudspeaker providing an alarm effect to alter the guardian of the state of the infant when the infant cries or moves abnormally. However, the guardians, often the parents of the infant, are both woken up by the alarm and, thus, can not sleep well especially at night.

Thus, a need exists for a wireless alarm system that can send the alarm to alert only one of the guardians so that other guardians will not be disturbed while sleeping.

### BRIEF SUMMARY OF THE INVENTION

The present invention solves this need and other problems in the field of monitoring of infants by providing, in a preferred form, a wireless infant state alarm system including a detecting device adapted to be placed adjacent an infant. The detecting device includes an external signal receiver for receiving an external signal indicative of at least one of movement and sound of the infant. The detecting device further includes a signal transmitter receiving and converting the external signal into a wireless signal indicative of at least one of the movement and the sound of the infant and transmitting the wireless signal. A first alarm device is adapted to be placed adjacent a guardian of the infant and includes a first signal receiver and a vibrator. The first signal receiver receives the wireless signal from the signal transmitter, and the vibrator vibrates to alert the guardian of a state of the infant.

In a preferred form, the external signal receiver includes an image receiver and a sound receiver. The first alarm device further includes a control unit electrically connected to the vibrator and a loudspeaker electrically connected to the control unit. The control unit activates at least one of the vibrator and the loudspeaker to alert the guardian of the state of the infant. The detecting device further includes a sensitivity adjuster capable of adjusting sensitivity of the external signal receiver to at least one of the sound and the movement of the infant. The wireless infant state alarm system further includes a second alarm device including a control unit, a display electrically connected to the control unit, a loudspeaker electrically connected to the control unit, and a second signal receiver. The second signal receiver receives the wireless signal from the signal transmitter. The display outputs image of the movement of the infant through control of the control unit, and the loudspeaker outputs the sound of the infant through control of the control unit. Furthermore, the loudspeaker can generate alarming sound effect to alert the guardian.

The first alarm device can be carried by the guardian. Especially at night, only the guardian carrying the first alarm device is woken up by the vibration of the vibrator without waking up others in sleep.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a schematic view illustrating use of a wireless infant state alarm system according to the preferred teachings of the present invention.

FIG. 2 shows a schematic block diagram of a wireless infant state alarm system of a first embodiment according to the preferred teachings of the present invention.

FIG. 3 shows a schematic block diagram of a wireless infant state alarm system of a second embodiment according to the preferred teachings of the present invention.

FIG. 4 shows a schematic block diagram of a wireless infant state alarm system of a third embodiment according to the preferred teachings of the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

A wireless infant state alarm system according to the preferred teachings of the present invention is shown in the drawings and generally includes a detecting device 3 adjacent an infant 1 and at least one alarm device 4 adjacent a guardian 2 of the infant 1. In a case that the detecting device 3 detects a preset abnormal state of the infant 1, a wireless signal is transmitted to the alarm device 4 that can generate at least one of sound, image, or vibration to alter the guardian 2 of the state of the infant 1.

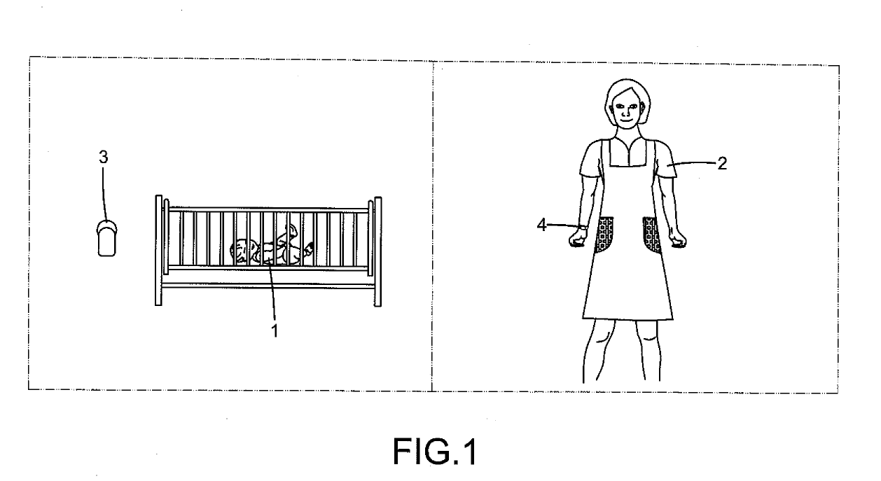

In the first embodiment shown in FIG. 1, the detecting device 3 includes an external signal receiver 30 for receiving external signal, a sensitivity adjuster 33, and a signal transmitter 34. The external signal receiver 30 includes a sound receiver 31 for detecting crying of the infant 1 and an image receiver 32 for receiving abnormal movement or transmitting instant image of the infant 1. Thus, when the infant 1 cries or moves abnormally, the signal transmitter 34 converts the external signal indicative of crying and/or abnormal movement of the infant 1 into a wireless signal and sends the wireless signal to the alarm device 4 to alert the guardian 2 of the state of the infant 1. The sensitivity adjuster 33 allows control of the sensitivity of the external signal receiver 30 to at least one of the movement and the sound of the infant 1 to be in a proper mode. The external signal receiver 30 can include a high-sensitivity mode, a medium-sensitivity mode, and a low-sensitivity mode.

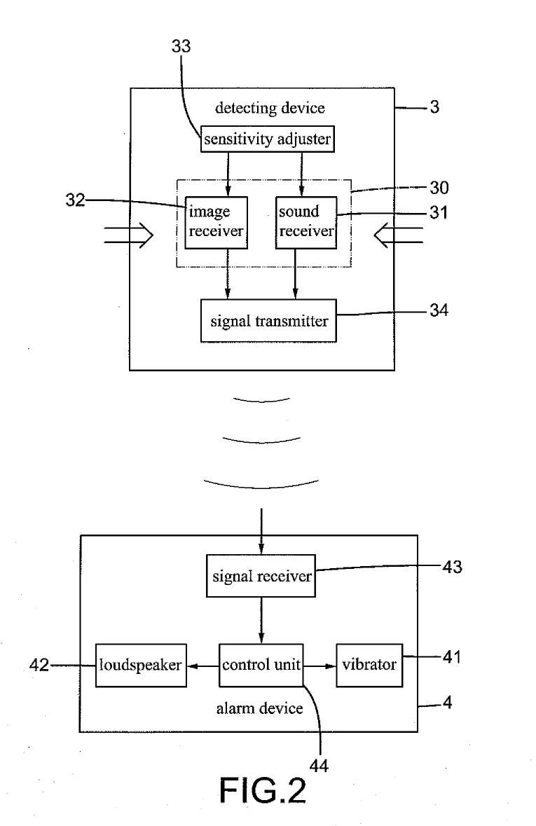

The alarm device 4 includes a signal receiver 43, a control unit 44 electrically connected to the signal receiver 43, and a vibrator 41 electrically connected to the control unit 44. When the signal receiver 43 receives the wireless signal from the detecting device 3, the control unit 44 activates the vibrator 41 to vibrate, alerting the guardian 2 of the state of the infant 1. In the preferred form shown in FIG. 2, the control unit 44 is electrically connected to a loudspeaker 42 that can output alarming sound effect when the signal receiver 43 receives the wireless signal from the detecting device 3. Thus, the control unit 44 can activate one or both of the loudspeaker 42 and the vibrator 41 when the signal receiver 43 receives the wireless signal from the detecting device 3.

In the first embodiment shown in FIG. 2, the alarm device 4 can be in the form of a bracelet or a watch so that the alarm device 4 can be carried on a wrist of the guardian 2. Furthermore, the alarm device 4 can be switched between a sound mode, a vibration mode, and a sound/vibration mode. At night, the guardian 2 can select the vibration mode so that it will not wake up others in sleep.

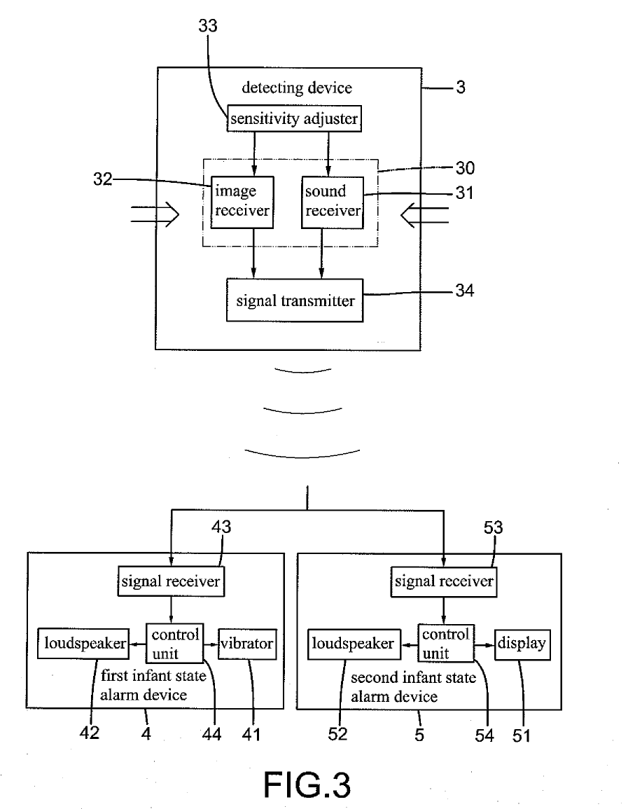

In a second embodiment shown in FIG. 3, the wireless infant state alarm system according to the preferred teachings of the present invention includes a detecting device 3 adjacent the infant 1 and first and second infant state alarm devices 4 and 5 adjacent the guardian 2 of the infant 1. The detecting device 3 is substantially the same as that in the first embodiment shown in FIG. 2. The first infant state alarm device 4 is the same as the infant state alarm device 4 of the first embodiment shown in FIG. 2. The second infant state alarm device 5 includes a signal receiver 53, a control unit 54 electrically connected to the signal receiver 53, a display 51 electrically connected to the control unit 54, and a loudspeaker 52 electrically connected to the control unit 54. When the signal receiver 53 receives the wireless signal from the signal transmitter 34 of the detecting device 3, the control unit 54 activates the display 51 and the loudspeaker 52, alerting the guardian 2 of the state of the infant 1.

In the second embodiment shown in FIG. 3, the display 51 cooperates with the image receiver 32 of the detecting device 3, so that the guardian 2 can see the instant image of the infant 1 through the display 51 by wireless transmission. The loudspeaker 52 cooperates with the sound receiver 31 of the detecting device 3, so that the guardian 2 can heat the sound of the infant 1 through the loudspeaker 52 by wireless transmission. The control unit 44 can be switched between a video mode, a sound mode, and a video/sound mode.

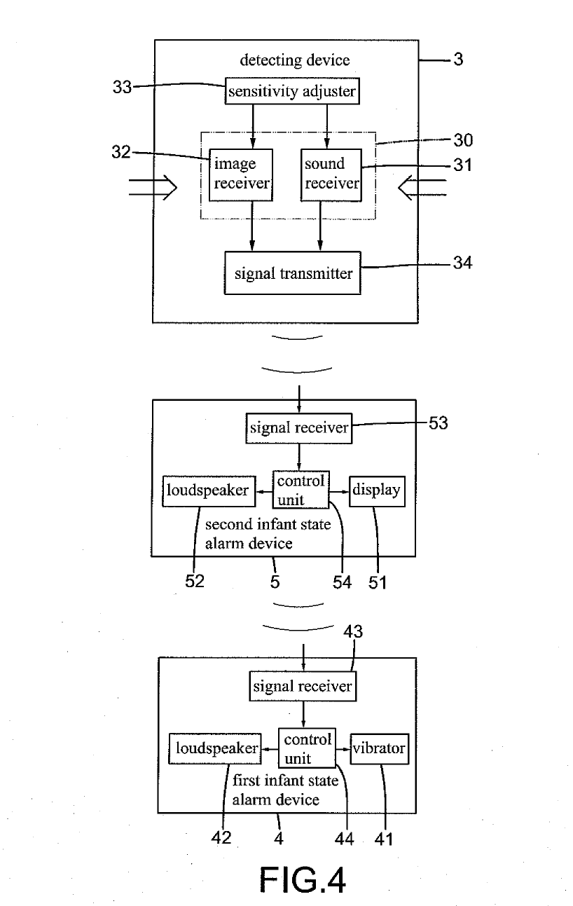

In a third embodiment shown in FIG. 4, the wireless infant state alarm system according to the preferred teachings of the present invention includes a detecting device 3 adjacent the infant 1 and first and second infant state alarm devices 4 and 5 adjacent the guardian 2 of the infant 1. The detecting device 3 is substantially the same as that in the second embodiment shown in FIG. 3. The first infant state alarm device 4 is the same as the infant state alarm device 4 of the second embodiment shown in FIG. 3. In addition to the signal receiver 53, the control unit 54, the display 51, and the loudspeaker 52, the second infant state alarm device 5 includes a signal transmitter 55. When the signal receiver 53 receives the wireless signal from the signal transmitter 34 of the detecting device 3, the control unit 54 activates the display 51 and/or the loudspeaker 52, alerting the guardian 2 of the state of the infant 1. Furthermore, the control unit 54 controls transmission of wireless signal of the transmitter 55. When the guardian 2 is going to sleep, one or both of the display 51 and the loudspeaker 52 can be deactivated through operation of the control unit 54. Furthermore, when the infant I cries or moves abnormally, the signal transmitter 55 sends a wireless signal indicative of at least one of the movement and the sound of the infant I to the signal receiver 43 of the first alarm device 4, so that the vibrator 41 vibrates to alert the guardian 2 of the state of the infant 1. The first and second alarm devices 4 and 5 are usually located in the same room or adjacent to each other, such that the first alarm device 4 can have light weight and require only little power.

In the second embodiment, the detecting device 3 cooperates with two alarm devices 4 and 5 having different alarming approaches to meet different needs.

The wireless transmission can be accomplished using any currently available techniques including, but not limited to, GPRS (general packet radio service). The alarm device 4 does not have to include the loudspeaker 42, such that the guardian 2 can be alerted by vibration of the vibrator 41.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A wireless infant state alarm system comprising, in combination:
a detecting device adapted to be placed adjacent an infant, with the detecting device including an external signal receiver for receiving an external signal indicative of at least one of movement and sound of the infant, with the detecting device further including a signal transmitter receiving and converting the external signal into a wireless signal indicative of at least one of the movement and the sound of the infant and transmitting the wireless signal; and
a first alarm device adapted to be placed adjacent a guardian of the infant, with the first alarm device including a first signal receiver and a vibrator, with the first signal receiver receiving the wireless signal from the signal transmitter, with the vibrator vibrating to alert the guardian of a state of the infant.

2. The wireless infant state alarm system as claimed in claim 1, with the external signal receiver including at least one of an image receiver and a sound receiver.

3. The wireless infant state alarm system as claimed in claim 1, further comprising, in combination: a second alarm device including a control unit, a display electrically connected to the control unit, a loudspeaker electrically connected to the control unit, and a second signal receiver, with the second signal receiver receiving the wireless signal from the signal transmitter, with the display outputting image of the movement of the infant through control of the control unit, and with the loudspeaker outputting the sound of the infant through control of the control unit.

4. The wireless infant state alarm system as claimed in claim 3, with the loudspeaker generating alarming sound effect to alert the guardian.

5. The wireless infant state alarm system as claimed in claim 1, with the first alarm device further including a control unit electrically connected to the vibrator and a loudspeaker electrically connected to the control unit, with the control unit activating at least one of the vibrator and the loudspeaker to alert the guardian of the state of the infant.

6. The wireless infant state alarm system as claimed in claim 1, with the detecting device further including a sensitivity adjuster adjusting sensitivity of the external signal receiver to at least one of the sound and the movement of the infant.

7. A wireless infant state alarm system comprising, in combination:
a detecting device adapted to be placed adjacent an infant, with the detecting device including an external signal receiver for receiving an external signal indicative of at least one of movement and sound of the infant, with the detecting device further including a first signal transmitter receiving and converting the external signal into a first wireless signal indicative of at least one of the movement and the sound of the infant and transmitting the first wireless signal;
a first alarm device adapted to be placed adjacent a guardian of the infant, with the first alarm device including a first signal receiver and a vibrator; and
a second alarm device including a control unit a display electrically connected to the control unit, a second signal receiver, and a second signal transmitter, with the second signal receiver receiving the first wireless signal from the first signal transmitter, with the display outputting image of the movement of the infant through control of the control unit, with the second signal transmitter sending a second wireless signal indicative of at least one of the movement and the sound of the infant,
with the first signal receiver receiving the second wireless signal from the second signal transmitter, with the vibrator vibrating to alert the guardian of a state of the infant.

8. The wireless infant state alarm system as claimed in claim 7, with the second alarm device further including a loudspeaker, and with the control unit activating one of both of the display and the loudspeaker.

9. A wireless infant state alarm system comprising, in combination:
a detecting device adapted to be placed adjacent an infant, with the detecting device including an external signal receiver for receiving an external signal indicative of at least one of movement and sound of the infant, with the detecting device further including a first signal transmitter receiving and converting the external signal into a first wireless signal indicative of at least one of the movement and the sound of the infant and transmitting the first wireless signal;
a first alarm device adapted to be placed adjacent a guardian of the infant, with the first alarm device including a first signal receiver and a vibrator; and
a second alarm device including a control unit, a loudspeaker electrically connected to the control unit, a second signal receiver, and a second signal transmitter, with the second signal receiver receiving the first wireless signal from the first signal transmitter, with the loudspeaker outputting an alarm sound effect through control of the control unit, with the second signal transmitter sending a second wireless signal indicative of at least one of the movement and the sound of the infant,
with the first signal receiver receiving the second wireless signal from the second signal transmitter, with the vibrator vibrating to alert the guardian of a state of the infant.

10. The wireless infant state alarm system as claimed in claim 9, with the control unit activating one of both of the display and the loudspeaker
